(19) United States
(12) Patent Application Publication
(10) Pub. No.: US 2008/0291674 A1
(43) Pub. Date: Nov. 27, 2008

(54) Lighting device utilizing an LED light source for projection of a light pattern onto a surface

(76) Inventor: Calvin Rex Welsh, JR., Coupeville, WA (US)

Correspondence Address: STRATTON BALLEW, 213 S 12TH AVE, YAKIMA, WA, 98902, US

(21) Appl. No.: 12/080,699

(22) Filed: Apr. 4, 2008

Related U.S. Application Data
(60) Provisional application No. 60/921,895, filed on Apr. 6, 2007.

(51) Int. Cl. F21S 13/14

(52) U.S. Cl. 362/236

(57) ABSTRACT

A lighting device utilizing a light emitting diode (LED) light source for projection of a light pattern onto a surface with an LED lamp socket, an adjustable LED lens attachment, and a mechanism for varying the focal length by adjusting the distance from the LED lamp socket relative to the lens attachment. The device preferably utilizes a replaceable, multiple LED lamp as a light source and a lighting fixture allowing for imaging of the LED light source onto a surface at varying distances from the light source. The device illuminates a surface with an image of the LED element array present in the replaceable lamp. Through adjustment of the LED lamp light source with respect to the imaging lens, the image of the LED array may be focused and distorted for a desired visual effect.

This application is a Non-Provisional Conversion Application claiming priority to Provisional Patent Application Ser. No. 60/921,895, filed Apr. 6, 2007.

### TECHNICAL FIELD

This invention relates generally to the field of architectural lighting and more specifically to a device utilizing an LED light source for projection of a light pattern onto a surface.

### BACKGROUND OF THE INVENTION

Architectural lighting devices and fixtures utilized in interior, exterior and landscape lighting systems range from commercial grade high voltage, broad surface illumination to residential grade low voltage, reduced area illumination. Interior devices and fixtures are typified by utilization of known lighting sources such as incandescent, halogen and fluorescent in conjunction with fixtures such as fixed can, tube and wall/ceiling mount to ordinary table and floor standing lamps. Exterior devices and fixtures are typified again by known lighting sources such as incandescent, halogen and fluorescent in conjunction with outdoor fixtures such as fixed spotlight, floodlight and wall/ground based accent lights. Landscape devices and fixtures are typified by utilization of high and low voltage incandescent and halogen in conjunction with outdoor fixtures for pathway, driveway and landscape feature illumination of trees, signs and sculptures. The significant limitation is that in virtually all cases, what is achieved is simple, general illumination of surfaces with accompanying shadowing common to these types of devices and fixtures. The pattern of illumination is non-specific, even in the case of so-called “spot” fixtures due to the inherent nature of large scatter and diffusion emanating from the light source as the result of shape, reflectors and lamp coatings. Another limitation is the extreme difficulty and general lack of means by which achievement of certain desired architectural effect of lighting specific areas can be accomplished. Another problem is the amount of power required and consumed in order to achieve the architectural effect of lighting specific areas due to the inherent inefficiency of the diffuse light sources in the devices and fixtures available.

Related technology includes the development of the light emitting diode (LED) flashlight, as described in U.S. Pat. No. 7,077,525. Recent development of so called “super bright” white LED's made this possible. The goal in utilizing LED elements as the light source was twofold. One goal was to reduce the amount of electrical power utilized by the flashlight thereby increasing battery life. This was achieved due to the inherent low current requirements relative to equivalent luminance found in the LED light source. Another goal was to produce uniform illumination of a surface or object at varying distances from the light source. Conventional flashlights tend to produce very non-uniform light resulting in uneven illumination and overall poor lighting results. Development of the LED flashlight resolved these issues.

The primary difficulty in utilizing LED elements to light surfaces and objects at considerable distance relates to their reduced luminance over standard incandescent light bulbs. This requires large numbers of LED elements to be used resulting in loss of one of the key advantages, low power consumption. Another deficiency of the device is with regard to resulting uniform surface illumination specifically designed to eliminate patterns and distortion often desirable in achieving specific architectural lighting effects.

The invention will be better understood by reference to the following detailed description taken in conjunction with the accompanying drawings.

### BRIEF DESCRIPTION OF DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1A is a partial cross sectional view of a portion of a lighting device, according to an embodiment of the invention;

FIG. 1B is a perspective view of the lighting device inserted into a ground surface, according to an embodiment of the invention;

FIG. 1C is a perspective view of the lighting device, according to an embodiment of the invention;

FIG. 2 is a schematic view of a portion of the lighting device, detailing operational features according to an embodiment of the invention;

FIG. 3 is an exploded partial cross sectional view of a portion of the lighting device, according to an embodiment of the invention;

FIG. 4 is an exploded perspective view of a portion of the lighting device, according to an embodiment of the invention; and

FIG. 5A is a perspective view of a portion of the lighting device in an extended position, according to an embodiment of the invention; and

FIG. 5B is a perspective view of a portion of the lighting device in a retracted position, according to an embodiment of the invention.

### DETAILED DESCRIPTION OF SPECIFIC EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

For the purposes of explanation, specific embodiments are set forth to provide a thorough understanding of the present invention. However, it will be understood by one skilled in the art and from the reading the disclosure, that the invention may be practiced without these details. Moreover, well-known elements, process steps and the like, and including, but not limited to, optical components, electronic circuitry components and connections, are not set forth in detail in order to avoid obscuring the disclosed system.

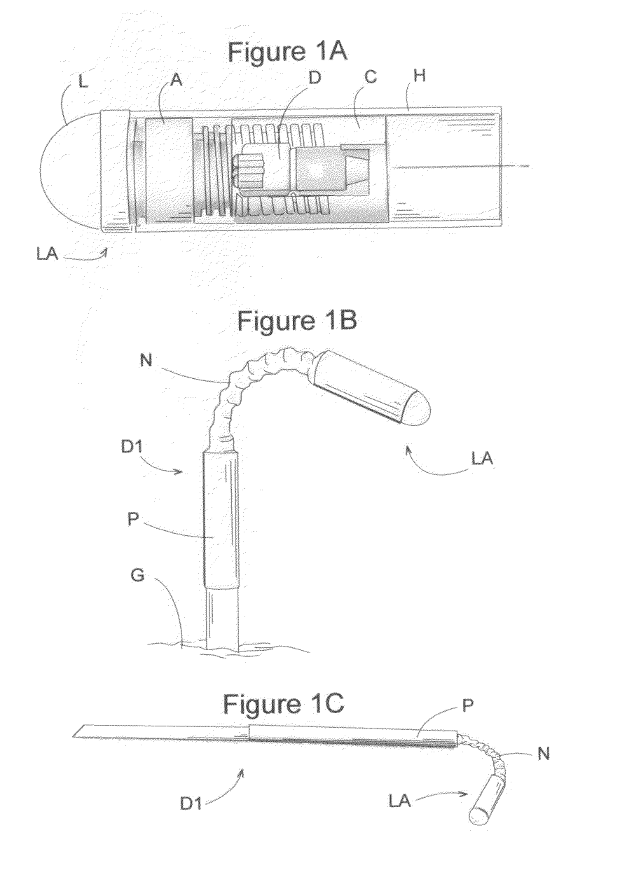

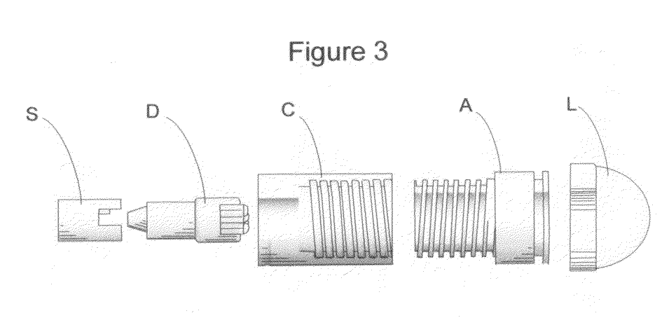

In accordance with a preferred embodiment of a lighting device D1 of the present invention, with one purpose of the lighting device to be utilized in interior and outdoor landscape lighting for achieving novel architectural effects utilizing a conventional low power LED lamp. FIG. 1A shows a cross sectional view of a portion of this preferred embodiment, the lighting device incorporates an LED Light Assembly LA, or simply referred to herein as a light assembly. The LED Light Assembly LA, as shown in FIG. 1A and further detailed in the exploded view in FIG. 3, includes a housing H which serves to contain and provide a mount for the various components as further described herein.

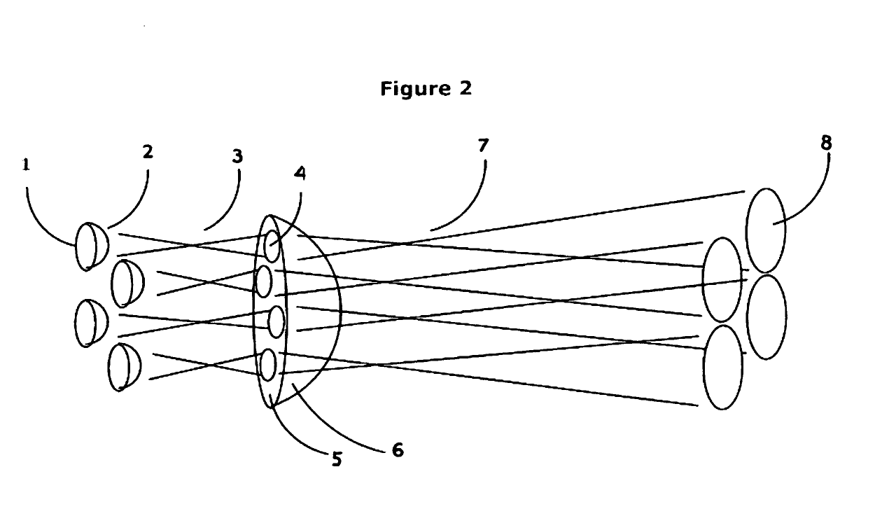

In a preferred embodiment of the present invention, a light source LS, comprising an LED lamp D containing four individual LED elements 1, encapsulated with lens, configured as a square array is shown schematically in FIG. 2. The LED lamp D is shown mounted in a typical ‘bayonet-type’ electrical lamp socket S, commonly utilized in the auto industry for mounting indicator, brake and turning signal lights. However, any LED lamp or ‘LED engine,’ with any number, or plurality of LED elements in any conventional ‘array’ or pattern, with any type of encapsulated lens, as known to those skilled in LED lens and array design, could be utilized in an alternative embodiment of the present invention, in order to create a desired lighting or illumination effect. One preferred type of LED lamp that could be utilized in the lighting device D1 is the LUXEON® III Emitter, selected to suit the desired lighting need, as manufactured by Philips Lumileds™ Lighting Company, of San Jose Calif., USA.

The lighting device D1 could be employed as a driveway and pathway light, as illustrated in FIG. 1B, and FIG. 1C. FIG. 1B specifically shows the lighting device with a post P inserted or staked into a ground surface G, for use as an accent light. Preferably, a flexible neck N can be utilized to connect the post P to the light assembly LA. The post could be any mount or stake alternative, as known to those skilled in such devices, just as the flexible neck could be any well known connector. As shown in FIG. 1A, the LED lamp D and lamp socket S are both encapsulated in an LED lamp carrier C. The LED lamp carrier C is shown interfaced with a lens adjuster A. The main lens L with a knurled base is shown affixed to the face of the lens adjuster A, providing for a means of varying the focal length of the device, as further described herein.

FIG. 2 schematically shows the projection path 3 of the light from the LED element(s) 1 through the lens 2 encapsulating the LED element(s) 1. An emitted pattern 4 of light from the LED element(s) 1 is then projected onto the surface 5 of the main lens 6. The pattern of light from the LED element(s) 1 is then projected 3 from its lens 2 and subsequently projected 7 through the main lens 6 onto a surface 9, substantially following an axis of projection AP. The focus, size and shape of a resulting light pattern 8 on the surface 9 may then be varied by adjusting the distance from the LED encapsulated lens 2 and the surface of the main lens 6. The surface may be close to the lens, or alternatively at a far away distance, nearing infinite as with a searchlight.

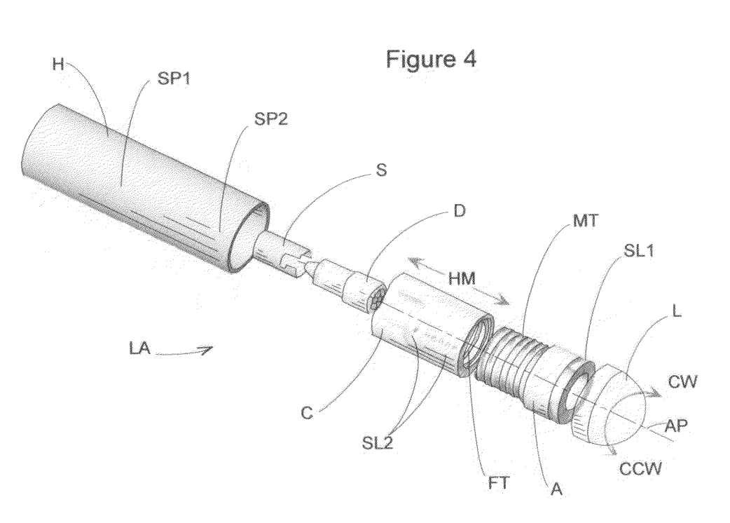

The exploded perspective shown in FIG. 4, shows the mechanical configuration by which the distance from the LED lamp D is adjustable relative to the surface of the main lens L, varying the focal length within the LED Light Assembly LA in order to create the desired light pattern effect, preferably for use in architectural or landscape illumination. The LED lamp D is capable of being solar powered, battery powered, or powered from any conventional DC power supply, or an AC power supply with a typical transformer. The LED element is most preferably a conventional, replaceable, ‘low-power’ type of multi-LED lamp, as are well known to those skilled in the design and manufacture of devices incorporating LED lamps. The LED lamp D is shown in FIG. 4, is plugged into the electrical bayonet-type light socket S. The socket S shown is then inserted and affixed into the base of the LED lamp carrier C. The main lens L shown is affixed to the face of the lens adjuster A. The lens adjuster A is then threaded into the LED lamp carrier C, preferably utilizing the male threads MT of the lens adjuster A into the female threads FT of the carrier C. This subassembly is then inserted into the LED Light Assembly case C. Alternatively, the lens adjuster could utilize female threads, and the carrier utilize male threads. As also shown in FIG. 4, there is preferably a guide slot SL2 in the LED lamp carrier C, oriented longitudinally along the surface of the carrier C. Once the subassembly is inserted, this guide slot SL2 is aligned with a set point SP1 shown on the surface of the case H. There is a second guide slot SL1 shown in the lens adjuster A, oriented laterally along the surface of the lens adjuster A. Once the subassembly is inserted, this guide slot is aligned with set point SP2. After insertion, set-screws are threaded into a first set point SP1, and a second set point SP2.

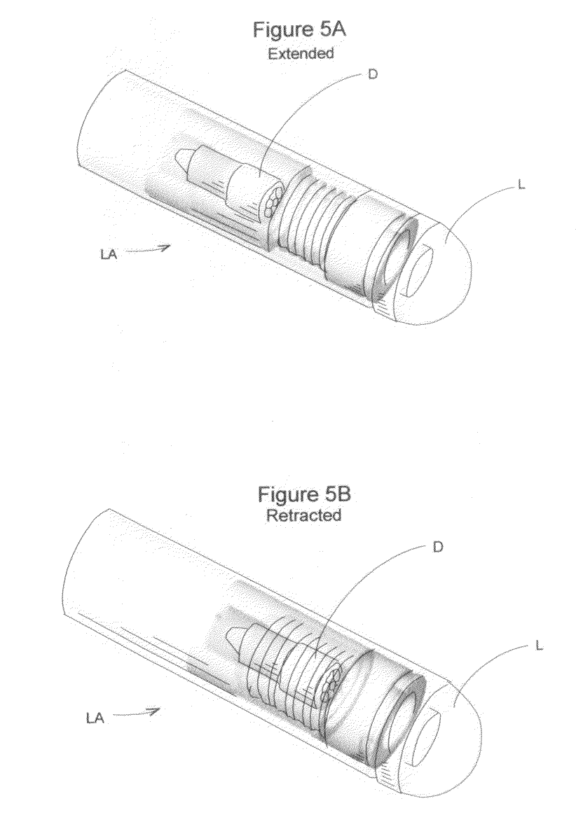

The lighting device D1 preferably utilizes the LED light source LS for projection of a light pattern onto the surface 9. Additionally, the lens adjuster A controls the focus and size of the resulting and specifically desired light pattern on the surface. This linear adjustment of the lens adjuster, along the axis of projection AP and relative to the LED carrier, varies the distance from the light source to the surface, allowing for flexible placement of the light source LS. As is most preferred, when the lens adjuster A is rotated either clockwise (CW) or counter clockwise (CCW), the LED carrier C moves linearly along the axis of projection AP, with respect to the lens adjuster A, varying a focal length HM from the LED lamp D and the surface of the main lens L. Specifically, clockwise rotation (CW) results in the LED lamp D being retracted, decreasing the distance and associated focal length HM of the LED lamp D from the surface of the main lens L. Counter clockwise rotation (CCW) of the lens adjuster A results in the LED lamp D being extended, increasing the distance and associated focal length HM of the LED lamp D from the surface of the main lens L. FIG. 5A shows the focal length extended, or lengthened, as the result of counter clockwise rotation (CCW) of the lens adjuster A. FIG. 5B shows the focal length retracted, or shortened, as the result of clockwise rotation (CW) of the lens adjuster A. The threading of the adjuster A into the LED lamp carrier C is an adjustment means for varying the distance from the LED lamp socket S, relative to the adjustable main lens L.

Again, while the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above, for instance in the application to crop drying and crop cooling systems and methods. Therefore, the invention is not to be limited except by the following claims, as appropriately interpreted in accordance with the ‘doctrine of equivalents.’

The following is claimed:

1. A lighting device utilizing an LED light source for projection of a light pattern onto a surface, the lighting device comprising:
a light assembly including an LED lamp, the light assembly received into an LED lamp socket held within an LED lamp socket carrier;
a lens adjuster including a lens, the lens adjuster movable in a linear relation to the LED lamp socket carrier; and
a focal length between the lens and the LED lamp, the focal length adjustable by moving the lens adjuster relative the LED lamp socket carrier along an axis of projection.

2. The lighting device of claim 1, wherein the lighting assembly includes a plurality of LED lamps.

3. The lighting device of claim 1, wherein the lens adjuster is movable in the linear relation to the LED lamp socket carrier about a threaded connection to the LED lamp socket carrier.

4. The lighting device of claim 1, wherein the light assembly is connected to the LED lamp socket with a bayonet type of connection.

5. The lighting device of claim 1, wherein a flexible neck connects a post to the light assembly.

6. A lighting device utilizing an LED light source for projection of a light, the lighting device comprising:
a light assembly including a plurality of LED lamps held within an LED lamp carrier;
a lens adjuster including a lens, the lens adjuster movable in a linear relation to the LED lamp carrier; and
a focal length between the lens and the plurality of LED lamps, the focal length adjustable by moving the lens adjuster relative the LED lamp socket carrier along an axis of projection.

7. The lighting device of claim 1, wherein the lighting device projects a light pattern onto a surface.

8. The lighting device of claim 1, wherein the lens adjuster is movable in the linear relation to the LED lamp socket carrier about a threaded connection to the LED lamp socket carrier.

9. The lighting device of claim 1, wherein the light assembly is connected to the LED lamp socket with a bayonet type of connection.

10. The lighting device of claim 1, wherein a flexible neck connects a post to the light assembly.
